(19) United States
(12) Patent Application Publication
(10) Pub. No.: US 2002/0141560 A1
(43) Pub. Date: Oct. 3, 2002

(54) Group establishment system and method

(76) Inventors: Media Khayatan, Kista (SE); Anders Isven, Hagersten (SE)

Correspondence Address: SMITH, DANAMRAJ & YOUST, P.C., Suite 1200, LB-15, 12900 Preston Road, Dallas, TX, 75230-1328, US

(21) Appl. No.: 09/993,013

(22) Filed: Nov. 6, 2001

(30) Foreign Application Priority Data
Mar. 27, 2001 (SE) 0101117-0

(51) Int. Cl. H04M 7/00

(52) U.S. Cl. 379/219

(57) ABSTRACT

A Group Establishment System (GES) and method of establishing and managing groups of communicating individuals that enables fast and easy group establishment and management, and enables group members to communicate using a plurality of different communication devices. The present invention enables non-temporary groups to be easily and quickly established with just the push of a few buttons. Additional members can be easily invited to join. A customizable set of activities is provided for group members. The activities that are performed are logged in a GES database. Notifications of meetings, activities, and charges are automatically generated and sent to affected group members. The group can be deleted by an authorized Group Initiator (GI) or by consensus vote of the group members.

### PRIORITY STATEMENT UNDER 35 U.S.C. § 119(a)

This nonprovisional application claims priority based upon the prior Swedish patent application number 0101117-0 entitled, “Group Establishment”, filed Mar. 27, 2001 in the name of Media Khayatan.

### BACKGROUND OF THE INVENTION

1. Technical Field of the Invention

This invention relates to communication systems. More particularly, and not by way of any limitation, the present invention is directed to a system and method of establishing and managing groups of communicating individuals.

2. Description of Related Art

A group is defined as a collection of people. We are social beings who like to live and work in groups, and want to be able to keep in touch with colleagues, friends, and family as we move around. People join groups for a variety of reasons. Some group members are motivated by task concerns and others are motivated by interpersonal attraction to other group members. Some groups form spontaneously, such as a group of friends. Other groups are contrived, that is they are formed for a specific purpose. Organized clubs, social groups, or committees are contrived groups. Many groups meet to solve problems or make decisions. A group must have a common purpose or goal and group members must work together to achieve that goal. The goal brings the group together and holds it together. To be effective, a group's members must be able to communicate freely and openly with all of the other members of the group.

While all groups have both social and task dimensions, some groups are predominantly social in their orientation. Examples of these groups would be families and social clubs. These groups provide for our safety and solidarity needs and they help us develop self esteem. Work groups function to complete a particular task. In a work group, the task dimension is emphasized, and the group members pool their expertise to accomplish the task. Examples of this would be workplaces, campus organizations, or juries.

As our society has become more mobile, it has become more global. People with similar interests or needs have become spread around the world. Thus, it has become increasingly difficult for them to establish and manage groups. Global communications networks such as the Internet have provided a basic vehicle through which people in distant locations can communicate. However, the ability to establish and manage groups on the Internet is still very limited. For example, people can join “chat rooms” where topics of common interest are discussed, but an individual member cannot contact specific other members unless they take the discussion “off line” and personally contact each other. Additionally, a person in charge of disseminating information to a group can set up an e-mail address list containing the addresses of the group members. Then, by sending a single e-mail, the entire group is notified. However, further group interaction is limited. In addition, the group members are limited to using their PC or equivalent to communicate with other members of the group.

Mobile telecommunications networks also provide various communications and messaging services. However, these services have not been widely successful, and their functionality is not satisfactory for establishing and managing groups for a variety of reasons. First, the actual content and services often do not match people's expectations. Second, many of the services are difficult to operate, and it takes too much time to reach the desired service. Third, none of the services provide features that satisfy all the users' needs, so many people find that the services do not actually help their communications. Finally, although existing conference systems may establish a “group” for the duration of a conference call, when the call is terminated, the group is also terminated.

### SUMMARY OF THE INVENTION

In order to overcome the disadvantage of existing Internet communication systems and teleconferencing systems, the present invention provides a system and method of establishing and managing groups of communicating individuals that enables fast and easy group establishment and management, and enables members to communicate using a plurality of different devices. The present invention enables non-temporary groups to be easily and quickly established with just the push of a few buttons. Additional members can be easily invited and joined with the group. Once a group is established, it continues to exist for as long as the members desire. Within the group, a set of customizable activities are provided for group members. Each group member can customize his group features by adding or subtracting features. The activities that are performed are logged in a database. Notifications of meetings, activities, and charges are automatically generated and sent to affected group members. The group can be deleted by an authorized Group Initiator (GI) or by a consensus vote of the group members.

### BRIEF DESCRIPTION OF THE DRAWINGS

The invention will be better understood and its numerous objects and advantages will become more apparent to those skilled in the art by reference to the following drawings, in conjunction with the accompanying specification, in which:

FIG. 1 is a simplified block diagram illustrating a plurality of access mechanisms for use with the Group Establishment System (GES) of the present invention;

FIG. 2 is a simplified block diagram illustrating a plurality of interfaces used to access a main program within the GES;

FIG. 3 is a flow chart illustrating the steps in an illustrative process of initiating a group;

FIG. 4 is a flow chart illustrating the steps in an illustrative process showing the group in action;

FIG. 5 is a flow chart illustrating the steps in an illustrative process of registering a Group Initiator (GI) when the GI has an A-number;

FIG. 6 is a flow chart illustrating the steps in an illustrative process of registering a GI when the GI does not have an A-number;

FIG. 7 is a flow chart illustrating the steps in an illustrative process of registering an invitee;

FIG. 8 illustrates four exemplary notifications that may be sent by the GES to various members of the group;

FIG. 9 is a listing of the group features available in Group Activity in the GES;

FIG. 10 is a functional block diagram of the Group Contact feature illustrating the types of communication available to the group members through the GES;

FIG. 11 is a functional block diagram of the Invite feature illustrating the process by which the GI invites other people to the group;

FIG. 12 is a functional block diagram of the Options feature of the GES;

FIG. 13 is a functional block diagram of the Group List feature of the GES;

FIG. 14 is a functional block diagram of the Logger feature of the GES;

FIG. 15 is a functional block diagram of the Personal ID-Register feature of the GES;

FIG. 16 is a functional block diagram of the Delete feature of the GES;

FIG. 17 is a functional block diagram of the Delete Group sub-feature of the GES;

FIG. 18 illustrates two alternative notices that may be sent by the GES to group members following the deletion of a group when the GI has more power than the group members (GI>GM);

FIG. 19 illustrates two alternative notices that may be sent by the GES to group members when the deletion of the group has been requested by a group member, and the GI and group members have equal power (GI=GM);

FIG. 20 is a functional block diagram of the Delete Member sub-feature of the GES;

FIG. 21 illustrates two notices that may be sent by the GES following the deletion of a member when GI>GM;

FIG. 22 illustrates three notices that may be sent by the GES when the deletion of a member has been requested, and either GI>GM or GI=GM;

FIG. 23 is a functional block diagram of the Group Meetings feature of the GES;

FIG. 24 is a functional block diagram of the Internal Request feature of the GES;

FIG. 25 is a database table illustrating the first registration in the GES database when a group is first established;

FIG. 26 is a database table illustrating a subsequent registration in the GES database wherein group members enter data for their Personal ID-Cards;

FIG. 27 is a database table illustrating the registration of an activity in the GES database;

FIG. 28 is a database table illustrating the rights which the GI and others hold, and the priority of those rights when GI>GM;

FIG. 29 is a database table illustrating the rights which the GI and others hold, and the priority of those rights when GI=GM; and

FIG. 30 is a flow chart of a process by which the GES deals with external persons who are not group members.

### DETAILED DESCRIPTION OF EMBODIMENTS

The present invention, referred to herein as the Group Establishment System (GES), enables a group of individuals with mutual interests to establish a group and manage the group's activities with only a touch of a few buttons. The GES provides a new way of establishing groups. The group establishment system can be accessed by people anywhere and anytime, and is device-independent. Additionally, the system is easy to use and secure. The individuals in the group can maintain contact with all group members, book appointments with other group members, and have all the group contacts and information readily on hand. People with any kind of wireless or wireline communication device can access the GES. For example, mobile phones using voice, Short Message Service (SMS) or Wireless Application Protocol (WAP) can be used. Additionally, wireline devices such as a PC or laptop computer connected to the Internet, or even a legacy fixed phone can be used. This increases effective communication between the members of the group, helping the members better communicate and organize both their personal and business lives.

The group is initiated by a Group Initiator (GI) who starts the process by contacting the GES. The group is initially established in a stand-by mode. In other words, the GI can by contacting other people, invite them to join the group. However, when functioning as a stand-by group, the GES waits for invitees to contact the system and register as new group members.

The group is created when invitees decide to contact the GES to register for the group. The group is then activated from the stand-by mode. Once activated, all group members (GI and registered invitees) are able to use the group features for communicating with each other and for performing other group activities.

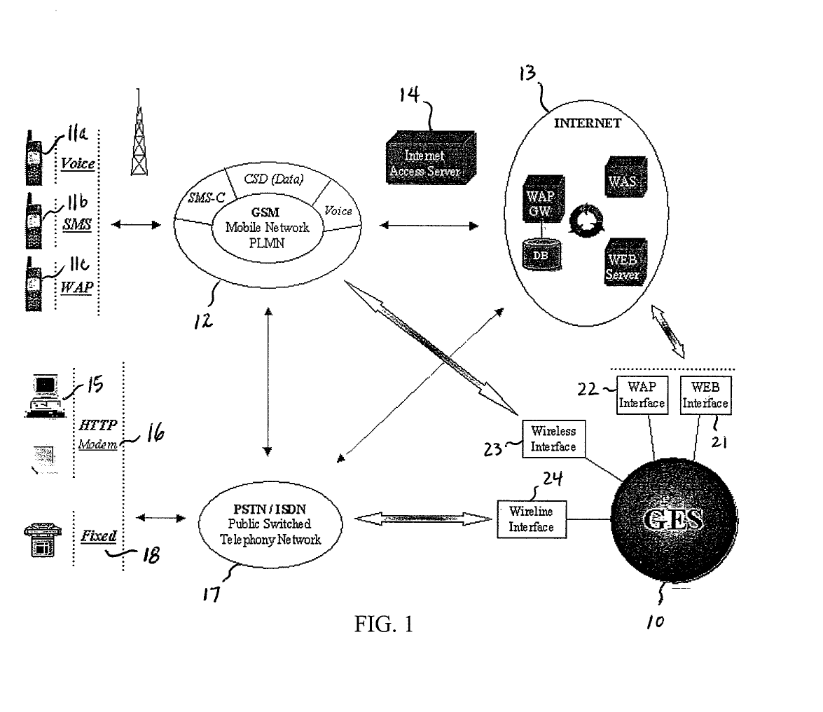

Since the GES is device independent, it is also independent of the communication system through which members access the GES. FIG. 1 is a simplified block diagram illustrating a plurality of access mechanisms for use with the GES 10. By using a mobile phone 11 (voice 11a, SMS 11b, or WAP 11c), users can connect to the GES through, for example a Global System for Mobile Communications (GSM) mobile network 12. A special web site 13 enables Internet users and WAP users to access the GES. WAP phone users have access to the GES web site, by going through the GSM mobile network 12, an Internet access server 14, and the Internet. Internet users 15, by using a modem 16, can be connected through the Public Switched Telephone Network/Integrated Services Digital Network (PSTN/ISDN) 17 to the Internet and to the GES web site. Users of fixed/wireline phones 18 may access the GES directly through the PSTN. Thus, accessibility to the system is diverse, covering essentially all possible communication systems.

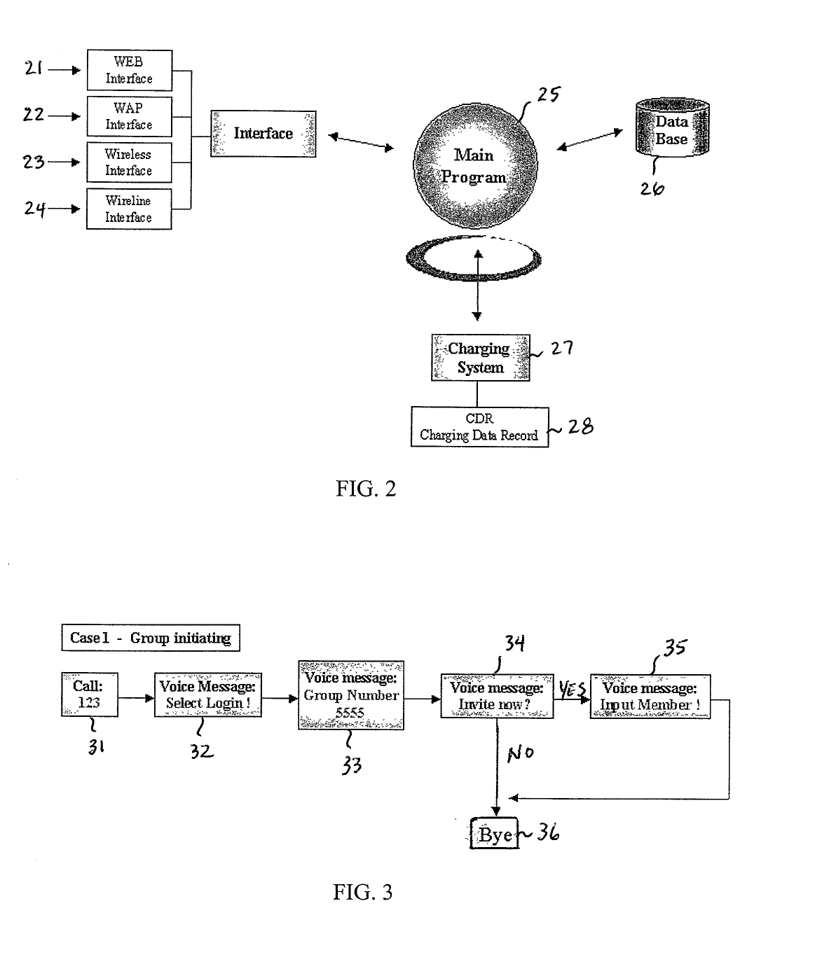

As shown in FIG. 2, a plurality of interfaces (e.g., WEB 21, WAP 22, wireless 23, and wireline 24) may be used to access the main program 25 within the GES application. The main program is located in a database 26. A charging system 27 also connects to the GES and fetches Charging Data Records (CDRs) 28 for later processing.

The GES 10 makes it possible for people to establish a group quickly and easily. For mobile and fixed phone users, the following process is followed. First, the Group Initiator (GI) calls a short number such as 123 to get connected to the GES. The GES then creates and registers a group with a special group number, for example, 5555. The GI receives the group number from the system, and then invites people into the group. Each invitee that calls 5555 is registered as a new group member. The GI's group is then in action.

In one embodiment, the GES creates a specific subscription number for every group. The advantage of this embodiment is that every group has its own number to call, which is also a short number like 5555.

In another embodiment, the group numbers are handled differently. For mobile and fixed phone users, the following process is followed. First, the Group Initiator (GI) calls a short number such as 123 to get connected to the GES. The GES then creates and registers a group with a special group number, for example, 5555. The GI receives the group number from the system, and then invites people into the group. Each invitee that calls 123/5555 (rather than 5555) is registered as a new group member. The GI's group is then in action. The next group may be assigned a sequential number such as 123/5556. If the GES has already created a group, the group members only have to call 123 followed by the group number, i.e. in this case 5555. The GES recognizes the group number, and when the group members are inside of the system, they can begin to use the group features. By this method there is only one subscription number, i.e. 123, registered from the operator's point of view.

Group Initiation

FIG. 3 is a flow chart illustrating the steps in an illustrative process of initiating a group. At step 31, the GI calls 123 in order to get connected to the GES 10. For security purposes, the GI may be asked at step 32 to select a login, i.e., to enter a user-ID and password. At step 33, a group number is initiated, and the GI is informed of the group number. This may be done, for example, through a voice or SMS message. At this point, the GI can choose between hanging up the phone and inviting members later, or immediately inviting members to join the group. Thus, at step 34, it is determined whether or not the GI desires to invite members now. If so, the GI inputs the invitee's number at step 35. If not, the process moves to step 36 and ends.

Group Activity

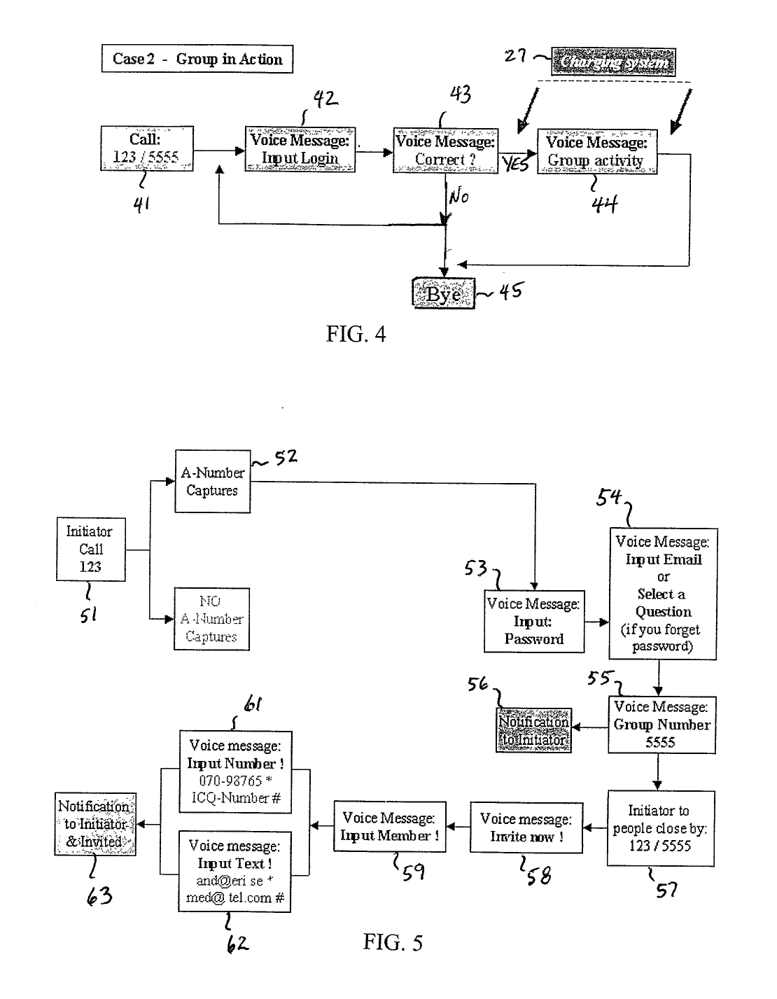

FIG. 4 is a flow chart illustrating the steps in an illustrative process showing the group in action.

After the GI completes the invitation process, the invitees, group members, and the GI call the group number (e.g., 123/5555) at step 41. At step 42, a voice message requests the GI or other group members to input their login information. If the login information is correct at step 43, a voice message tells them at step 44 that they have direct access to the group features (referred to herein as Group Activity). If the login information is incorrect, the process may return to step 42 and request that they input the login information again, or may end at step 45. If the caller has forgotten the password, the caller is given the opportunity to get it. In the case of invitees, the GES understands that they do not have login information yet, and asks the invitees to select a login instead. After the login process, the invitees can connect directly to the system and begin their Group Activity. The charging system 27 in FIG. 4 illustrates that the process of Group Initiating, itself, may be free of charge, but using the group features and Group Activity may cost extra for the users.

Registration

In order for the GES 10 to understand who is the GI, a group member, or an invitee, a registration process is utilized. The GES operates with a system that recognizes whether or not a calling party from a mobile phone has a registered A-number/MSISDN (user's mobile number subscription). If the user has an A-number, the GES registers the A-number as the member's user-ID. But if there is no A-number, or if the user has a protected number, then the GES cannot register any A-number. In this case, the GES requests the user to input a user-ID instead.

FIG. 5 is a flow chart illustrating the steps in an illustrative process of registering a GI when the GI has an A-number. At step 51, the GI calls 123 and gets connected to the GES 10. At step 52, the GI's A-number is captured by the GES and is used as the GI's user-ID. For security purposes, the GES requests the GI to input a password at step 53. Since people often forget their password, the process moves to step 54 where the GES asks the GI how he would like to be reminded of his password, if he forgets the password next time. There are two options here, either inputing an email address or selecting a question. At step 55, a voice message then informs the GI of the group number, e.g. 5555. At step 56, the GI recieves an information notification from the GES about the GES and group 5555.

At this point, the GI has two options, either to tell the group number (123/5555) to all people who are close by, or to invite other people who are not close by. In the example shown, the GI chooses to invite people close by at step 57. At step 58, a voice message prompts the GI to invite the people now. At step 59, a voice message prompts the GI to enter the invitee information. The GES provides the GI with two options if the GI chooses to invite people with the GES by inputting their numbers. The first option, shown at step 61, is used when the GI only has the invitees' telephone numbers (or any other contact numbers, e.g. ICQ-numbers). The second option, shown at step 62, is used when the GI only has, for example, an e-mail address for an invitee. This option enables the GI to type in text such as an e-mail address. When the invitations are completed, the GI and the invitees receive a notification at step 63. The notifications are discussed in more detail below.

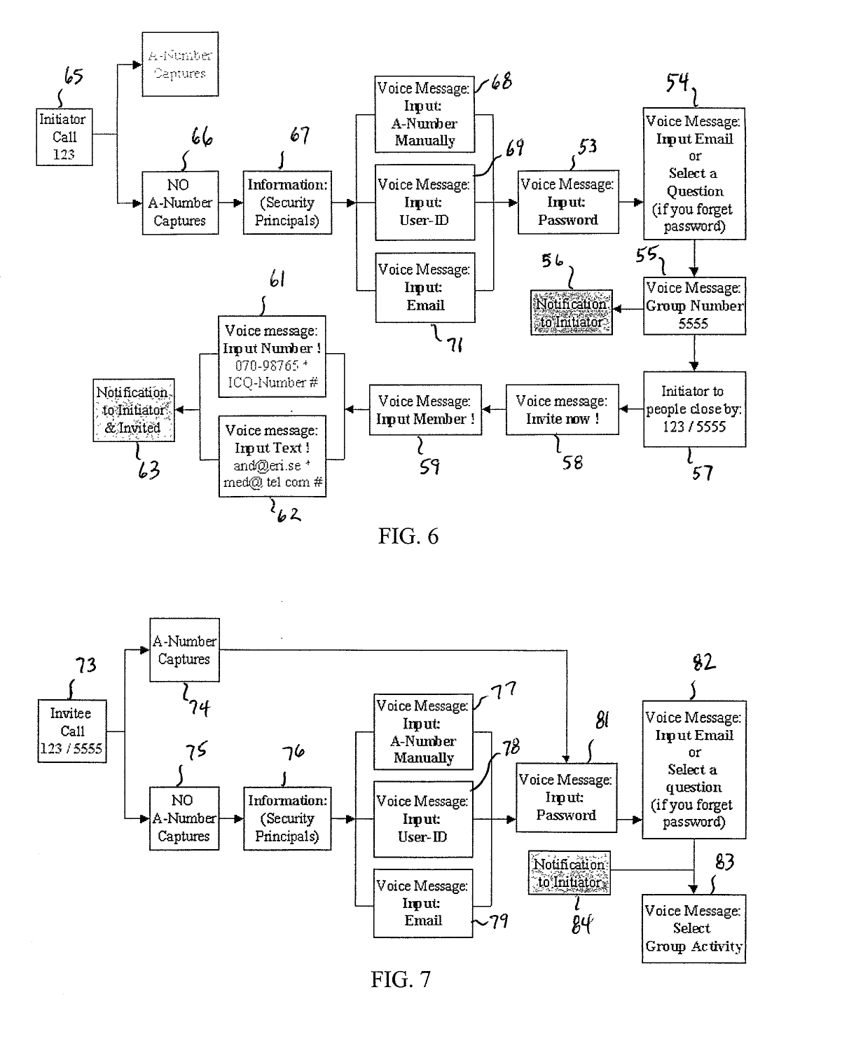

FIG. 6 is a flow chart illustrating the steps in an illustrative process of registering a GI when the GI does not have an A-number. At step 65, the GI calls 123 and gets connected to the GES 10. At step 66, the GES recognizes that the GI does not have an A-number, so the GI's A-number cannot be captured or used as the GI's user-ID. Therefore, the GES provides the GI with some other options instead. At step 67, the GES informs the GI that a password and user-ID are required for security reasons. There are several options at this point. The first option, shown at step 68, is for the GI to input the A-number manually. But the disadvantage of this option is that the GI can input any other phone number. Therefore, the GES sends a notification, just in case, to that manually input number as an invitation with a special user-ID. The second option, shown at step 69, is for the GI to input a user-ID. In this case, of course, it would not be possible for the GES to contact or send a notification to the GI. The third option, shown at step 71, is for the GI to input an e-mail address. The rest of the process is the same as shown in FIG. 5.

FIG. 7 is a flow chart illustrating the steps in an illustrative process of registering an invitee. At step 73, the invitee contacts the GES 10 by calling 123/5555. At steps 74 and 75, the GES looks for the invitee's A-number. If there is an A-number at step 74, the process moves directly to step 81 where the invitee is prompted to enter his password. If the invitee does not have an A-number, the process moves to step 76 where the GES informs the invitee that a password and user-ID are required for security reasons. There are several options at this point. The first option, shown at step 77, is for the invitee to input the A-number manually. Once again, the disadvantage of this option is that the invitee can input any other phone number. Therefore, the GES sends a notification, just in case, to that manually input number as an invitation with a special user-ID. The second option, shown at step 78, is for the invitee to input a user-ID. In this case, of course, it would not be possible for the GES to contact or send a notification to the invitee. The third option, shown at step 79, is for the invitee to input an e-mail address. After putting in the password at step 81, and selecting an option at step 82 if the invitee later forgets the password, the invitee can immediately select Group Activity at step 83. At the same time, a notification may be sent to the GI at 84, to inform the GI that the invitee has just registered.

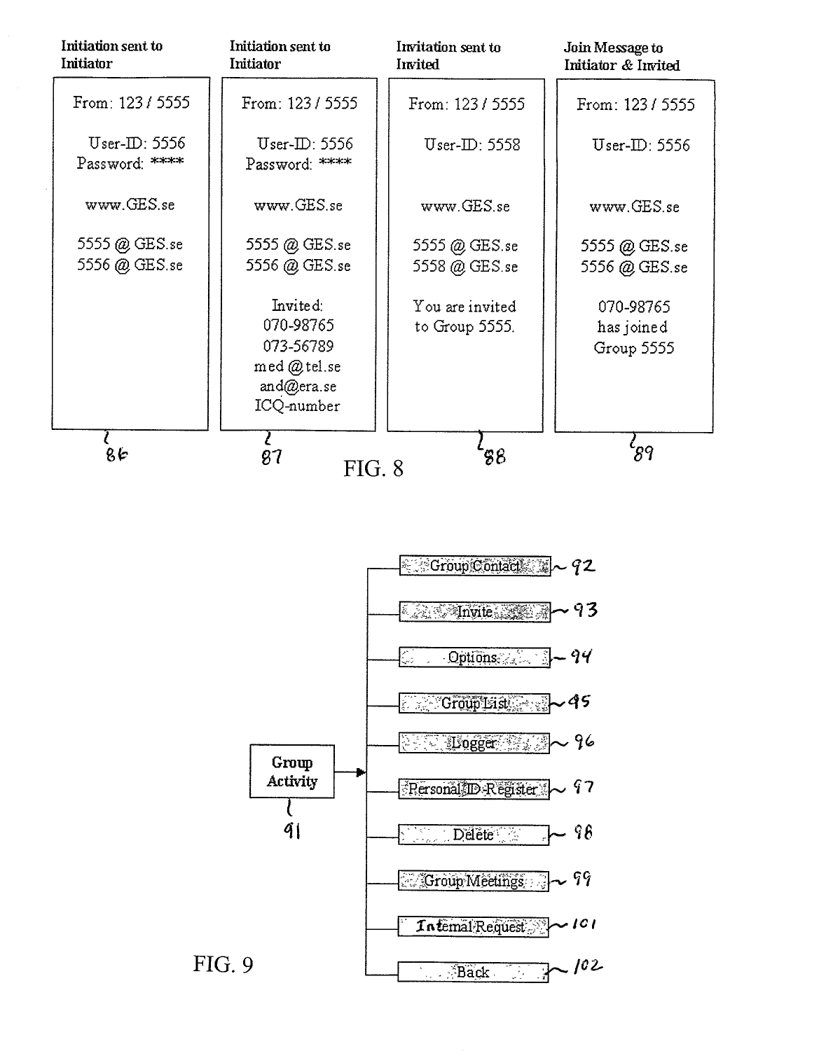

FIG. 8 illustrates four exemplary notifications that may be sent by the GES to various members of the group. The notifications may be sent, for example, to the GI and the invitees by SMS, e-mail, fax, or voice mail. Notification 86 is sent to the GI when the GI has initiated a group, and has invited people to the group by telling them the group number. The notification shows that it comes from the same group number, i.e. 123/5555. The GES always registers an internal user-ID for every group member. In this particular case, user-ID 5556 is chosen. The GI may also be notified on the GES web-site. The GES provides an internal e-mail address scheme for all group members. An e-mail address with the same number as the group number, works as a group e-mail. By sending e-mail to this address, every group member receives it. An e-mail address with a member's user-ID as the number (e.g., 5556) works as an individual member's e-mail address.

Notification 87 is sent to the GI after the GI invites people to the group by inputting their numbers into the GES. Notification 88 is sent to the invitee as an invitation with some information about the GES. Finally, notification 89 is sent to the GI and other group members when an invitee decides to join the group.

Group Activity

FIG. 9 is a listing of the group features available in the Group Activity function 91 in the GES 10. When the group is in action, the group members have direct access to Group Activity. The exemplary features shown in the Group Activity are important for any group to stay highly active and functional, and to make group members comfortable in the group. The features include Group Contact 92, Invite 93, Options 94, Group List 95, Logger 96, Personal-ID Register 97, Delete 98, Group Meetings 99, Internal Request 101, and Back 102. Each of the listed features is discussed in more detail below. It should be understood that the listed features are exemplary in nature, and features can be added or removed from the Group Activity list to suit particular groups. The ability to customize features is a key function of the GES 10.

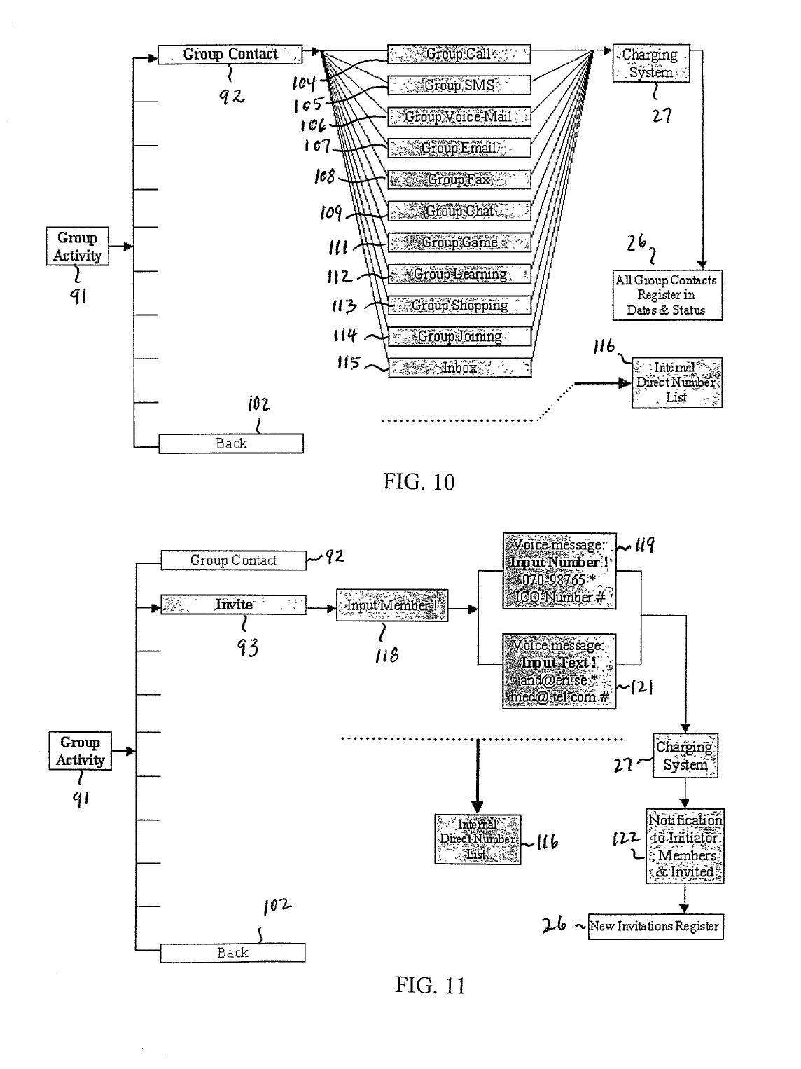

FIG. 10 is a functional block diagram of the Group Contact feature 92 illustrating the types of communication available to the group members through the GES 10. The Group Contact feature deals with how group members communicate with each other, and the different types of communication devices and networks that the members can utilize. This feature can be different if a fixed (wireline) phone is used, because of the bandwidth and circuit-switched limitations of the PSTN network. Exemplary options available to group members in the Group Contact feature include: Group Call 104, Group SMS 105, Group Voice-Mail 106, Group E-mail 107, Group Fax 108, Group Chat 109, Group Game 111, Group Learning 112, Group Shopping 113, Group Joining 114, and Inbox 115. Each of these options is described below. The Charging System 27 may also be utilized to charge group members for the use of Group Contact features. All Group Contact interactions are registered in the GES database 26 by date and status.

The Group Call feature 104 provides a group member with the ability to talk and have a voice conference with all other group members, depending on the limitations of the interfacing network. For example, in the GSM network, it is currently possible to have a group conversation between a maximum of eight parties. In cases where the group has more members, the GES 10 sends a notification to the group members about the limitation. The group member originating the call also has the option to choose only specific group members to participate in the Group Call.

Group SMS 105, Group Voice-Mail 106, Group E-mail 107, and Group Fax 108 are other ways in which group members in the GES 10 may communicate. By choosing these features, a group member can send SMS, voice-mail, email, and faxes to all other members or only to specifically identified members. Group Chat 109 is a chat communication for all group members via Internet, WAP, or SMS. Group Game 111 provides group members with the ability to send and recieve an invitation to, for example, a common Web address where all members can play data or video games. Group Learning 112 provides group members with the ability to apply for educational courses, for example, on the Internet or even on their mobile phones. Group Shopping 113 provides group members with the ability to shop in a smart, simple, and comfortable way while sharing shopping information with other group members. Group Joining 114 is a feature that makes it easier for all group members to apply and join other groups or service providers such as subscriptions for getting information and news. Finally, Group Activity 91 includes an internal Inbox system 115 that enables group members to check for incoming messages at any time.

Another function that applies to all of Group Activity 91 is called Internal Direct Number (IDN) 116. This function provides group members with faster access to particular features without having to go through a menu system and listen to instructional voice messages. IDN enables a member to use Group Activity by typing direct numbers to specific features. For example, a direct number to group SMS could be:

123/5555-(*user-ID)-*password-*01-*02-#

In this example, 01 is the number for Group Contact 92, the first feature within Group Activity, and 02 is the number for Group SMS 105, the second feature within Group Contact.

FIG. 11 is a functional block diagram of the Invite feature 93 illustrating the process by which the GI invites other people to the group. The Invite feature also enables other group members to invite people to the group, but in this case, the GI receives a request from the group members and decides whether the invitation will be sent since the GI is in charge of the group. As discussed above, the GI can send invitations either as digits for numbers or as text for e-mail addresses. FIG. 11 shows the prompts that the GES sends to the GI for inputting this information. At step 118, the GI is prompted to input the member. A first alternative at step 119 is to input the member number. Alternatively at step 121, the GI may input text such as the member's e-mail address. This information is sent to the charging system 27 so that invited members can be correctly charged for membership. At step 122, notifications are sent to the GI, group members, and invitees. All invitations are registered in the GES database 26.

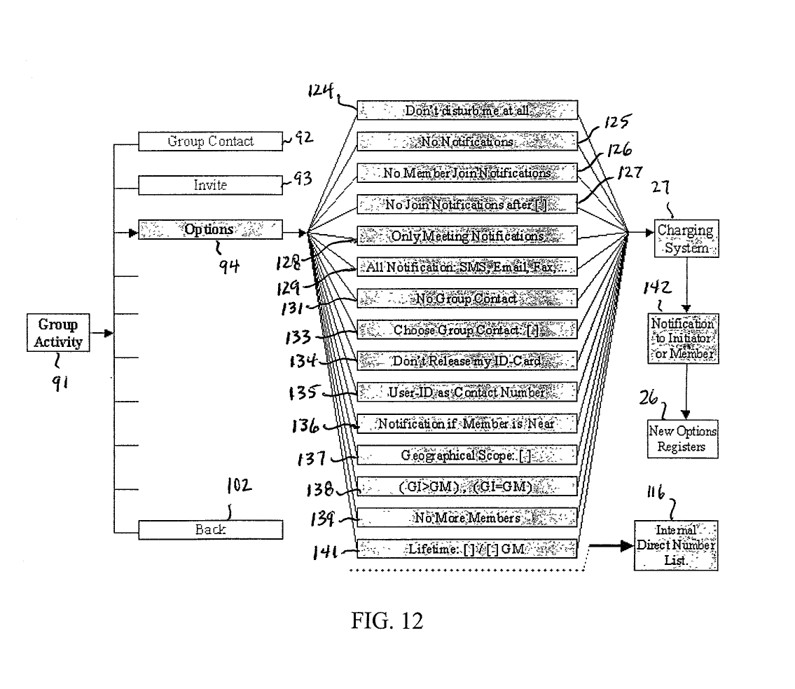

FIG. 12 is a functional block diagram of the Options feature 94 of the GES 10. This is a very important feature for all group members. It is a personal section which enables each group member to customize the GES functionality and all activities in the GES in any way that the member desires. There are a number of sub-features in the Options feature discussed below.

The first sub-feature may be referred to as the “Don't disturb me at all” sub-feature 124. When this sub-feature is selected, the group member will not get contacted from any other group members or by Group Contact 92, and will not recieve any kind of notifications from the GES. However, the member can still use Group Contact and when desired, check his Inbox for incoming messages. This sub-feature is always resettable. Another sub-feature, known as the “No Notifications” sub-feature 125 enables a group member to indicate that he does not want to receive any kind of notifications from the GES. However, the member can still be contacted by other group members using Group Contact 92. This sub-feature is also resettable at any time.

Other sub-features also enable each group member to limit the types of notifications that are sent to him. For example, by selecting the “No Member Join Notification” sub-feature 126, group members do not recieve any notifications from the GES when new members join the group. They can still be contacted by other group members using Group Contact 92, and will also recieve other kinds of notifications. This sub-feature is always resettable. By selecting the “No Join Notifications After [ ]” sub-feature 127, group members can set a limit on the number of new member notifications they want to receive. They can still be contacted by other group members using Group Contact 92, and will also recieve other kinds of notifications. This sub-feature is always changeable. By selecting the “Only Meeting Notifications” sub-feature 128, group members only recieve meeting notifications. They can still be contacted by other group members using Group Contact 92. This sub-feature is always resettable.

By selecting the “All Notifications: SMS, E-mail, Fax, Voice-Mail” sub-feature 129, group members are able to decide how they want to receive group notifications or system notifications. They can, for example, choose SMS, e-mail, fax, or voice-mail. This sub-feature is always changeable. By selecting the “No Group Contact” sub-feature 131, group members cannot be contacted by other group members using Group Contact 92. However, they are still able to recieve all kinds of notifications. This sub-feature is always resettable. By selecting the “Choose Group Contact” sub-feature 133, group members are able to indicate how they want to be contacted by other group members using Group Contact 92. They can choose any kind of Group Contact as shown in FIG. 10. This sub-feature is always changeable.

Another sub-feature referred to as the “Don't Release my ID-Card” sub-feature 134 enables group members to inform the GES that they do not allow the release of any kind of information to other group members or any external person. This sub-feature is always resettable. The GES 10 always initiates a personal user-ID for every group member. By selecting the “User-ID as Contact Number” sub-feature 135, a group members can inform the GES that they would like to use their user-ID as, for example, their telephone number. This feature is especially useful for those group members who do not have A-numbers, and therefore must input their number manually during registration. They would like to be contacted by group members, so by choosing this feature, all members can contact this member by a GES number such as 123/5558. The GES contacts the member by the real number without revealing it. This sub-feature is always resettable.

Another sub-feature referred to as the “Notification if Member is Near” sub-feature 136 enables a group member to request a notification if the member is close to another member or a particular identified member. This is especially useful if some of the group members are located in different geographic areas. For example, a member located in Stockholm, Sweden could receive a notification stating, “Maria is in Stockholm now! Would you like to contact her?”. This sub-feature is always resettable.

There are also several sub-features that can only be used by the GI. For example, the “Geographical Scope” sub-feature 137 enables the GI to determine what geographical scope the group will have. The GI can choose a city, a country, a whole continent, or even the whole world. For example, the GI can specify whether only people from Stockholm, Sweden or Europe can join the group. This sub-feature is always changeable. The “(GI>GM) or (GI=GM)” sub-feature 138 enables the GI to make decisions regarding group leadership by specifying whether the GI will stay as group leader (GI>GM), or all group members will be equal (GI=GM). This sub-feature is always resettable. The “No More Members” sub-feature 139 enables the GI to close the group to new members and other people. From the time that the GI closes the group, no one else can register in the GES by calling 123/5555. This sub-feature is always resettable. The “Lifetime:[ ]/[ ]GM” sub-feature 141 enables the GI to decide how long the group will be active. The GI can select between years, months, and days. The GI can also decide how long the group will stay active depending on the number of members. For example, the GI can decide that the group will stay active as long as there are more than 10 members in the group. This sub-feature is always changeable.

Whenever a member utilizes one of the Options sub-features, the Charging System 27 determines whether a charge is involved. If so, the GI and affected member are notified at step 142, and the transaction is registered in the GES database 26.

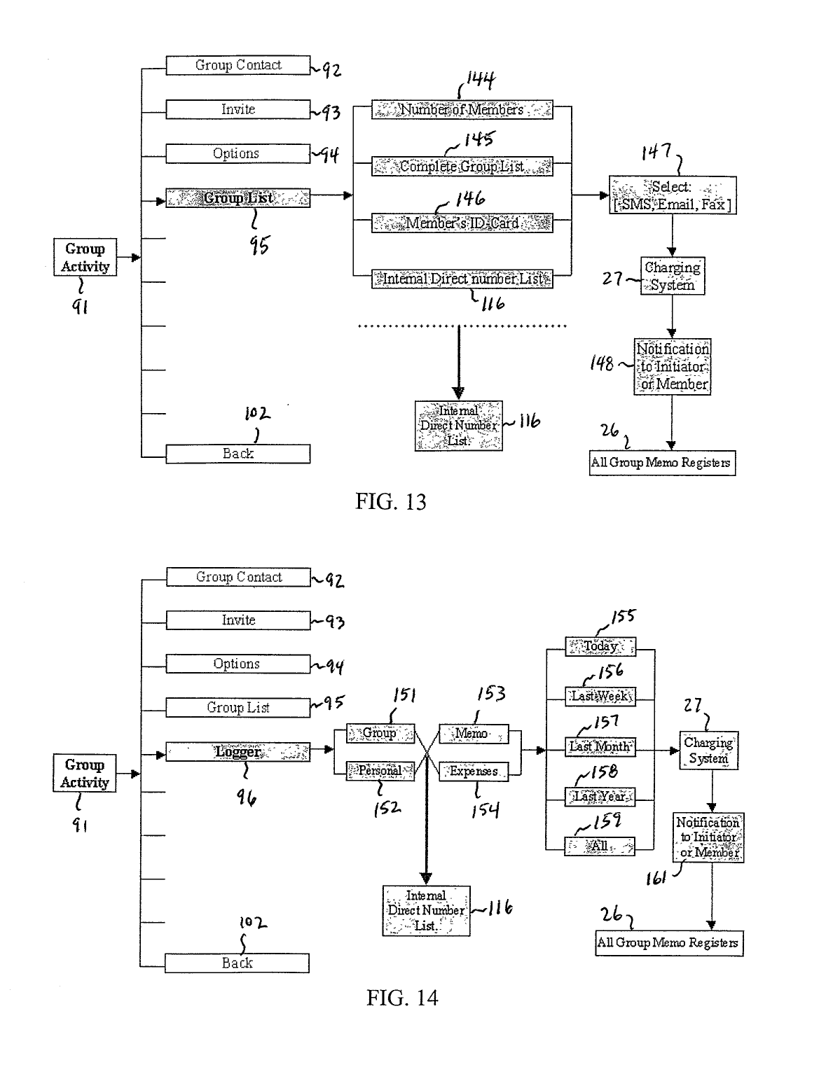

FIG. 13 is a functional block diagram of the Group List feature 95 of the GES 10. With this feature, all group members are able to learn more about their own group. By selecting the “Number of Members” sub-feature 144, they can learn exactly how many members are currently in the group. By selecting the “Complete Group List” sub-feature 145, they can obtain a complete list of the members, i.e. names and user-IDs. The “Member's ID-Card” sub-feature 146 provides all members with the opportunity to request all the information that the GES has registered on a particular member. The members can also designate at 147 how any requested information is to be delivered, e.g. by SMS, e-mail, Fax, and the like. Whenever a member utilizes one of the Group List sub-features, the Charging System 27 determines whether a charge is involved. If so, the GI and affected member are notified at step 148, and the transaction is registered in the GES database 26.

FIG. 14 is a functional block diagram of the Logger feature 96 of the GES 10. Logger is a feature that provides the group members with the capability to determine what is happening in the group. All group activity and all events get registered from the date of start in the GES database. All group members can choose between a “Group Logger” sub-feature 151 or a “Personal Logger” sub-feature 152. The Group Logger sub-feature is a complete list of all events and activities in the group. The “Personal Logger” sub-feature is a complete personal list of all events and activities of a particular group member. Furthermore the members can choose between a “Memo” sub-feature 153 and an “Expenses” sub-feature 154. The Memo sub-feature includes only events and activities. The Expenses sub-feature exists only if the group has expenses and costs. The members can also indicate what time period they are interested in, such as today 155, last week 156, last month 157, last year 158, or all time periods 159. Whenever a member utilizes one of the Logger sub-features, the Charging System 27 determines whether a charge is involved. If so, the GI and affected member are notified at step 161, and the transaction is registered in the GES database 26.

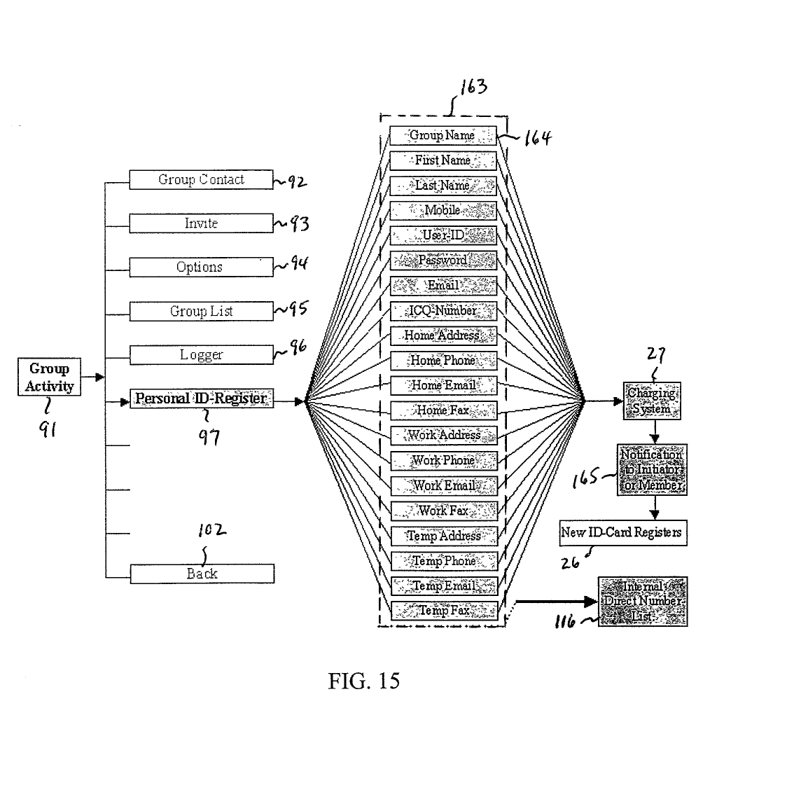

FIG. 15 is a functional block diagram of the Personal ID-Register feature 97 of the GES 10. All group members with this feature are able to make their own Personal ID-Card 163, by filling in all the information they want to provide. They can also change the existing information. Group members can learn more about a particular member (except the member's password) by requesting the member's ID-card. As described above, a group member can always choose the option “Don't Release my ID-Card” 134, and this information is not released. The sub-feature “Group Name” 164 is restricted to the GI, and enables the GI to rename the group. Whenever a member utilizes one of the Personal ID-Register sub-features, the Charging System 27 determines whether a charge is involved. If so, the GI and affected member are notified at step 165, and the transaction is registered in the GES database 26.

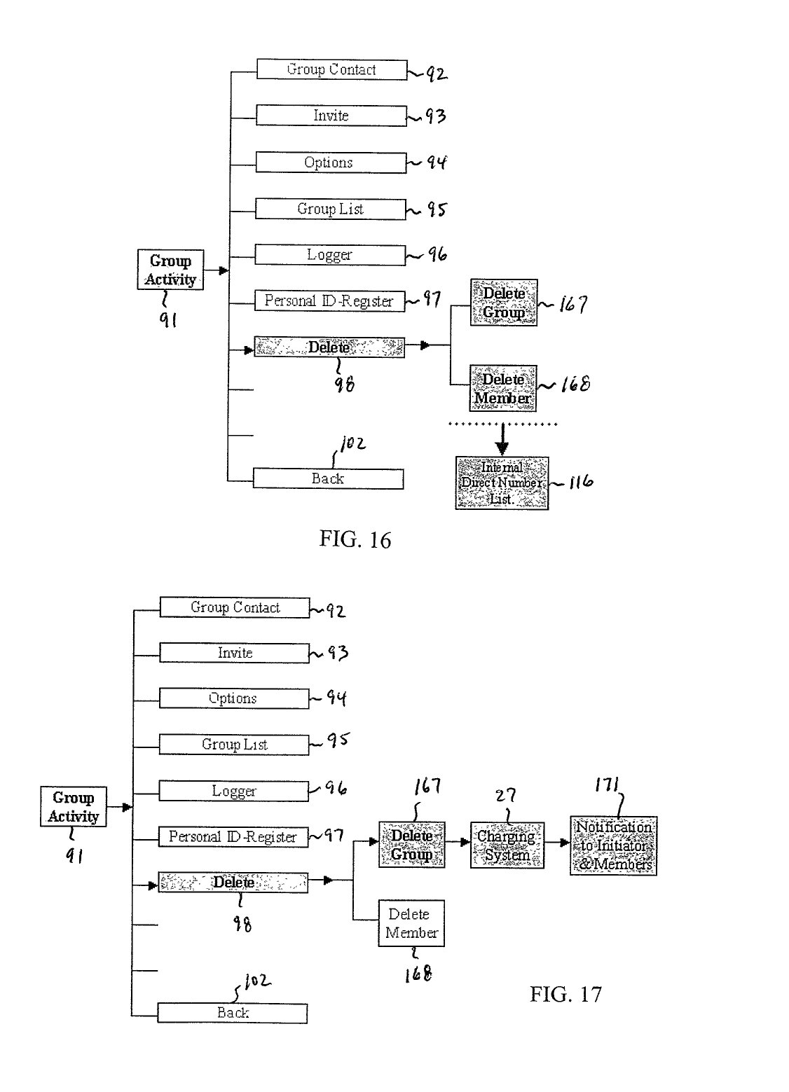

FIG. 16 is a functional block diagram of the Delete feature 98 of the GES 10. Although it may be a difficult decision to delete a group or a group member, such a feature may be required at times. The Delete feature provides the GI and group members with the ability to delete an entire group with the “Delete Group” sub-feature 167 or to delete a particular member of a group with the “Delete Member” sub-feature 168, with some special conditions.

FIG. 17 is a functional block diagram of the Delete Group sub-feature 167 of the GES 10. Additional considerations for such a sub-feature include determining whether members have the right to delete a group, or only the GI, when the GI is more powerful than the members (i.e., GI>GM). Additionally, if all group members are on an equal footing (i.e., GI=GM), then it must be determined whether anyone can delete the group. If the group is deleted, the Charging System 27 determines any final charges and affected members are notified at step 171.

FIG. 18 illustrates two alternative exemplary notices that may be sent by the GES 10 to group members following the deletion of a group when GI>GM. In this case, the GI, and only the GI, has the power to delete the group. The notices may be sent, for example, by SMS, e-mail, fax, or voice mail. In alternative-1 173, the group has expired following the group deletion, and the notification from the GES to the GI and the group members indicates that the group has expired. In alternative-2 174, the GES provides the same message, but gives all the members another chance to continue with the group by calling a new number (e.g., 8888). In some cases, some or all of the other group members may desire to continue with their old group. The GES still has all of the group members' information registered, and opens the group for those old members who call the new number. At this point, the GES may automatically choose a new GI, or the first person who calls the new number may be designated.

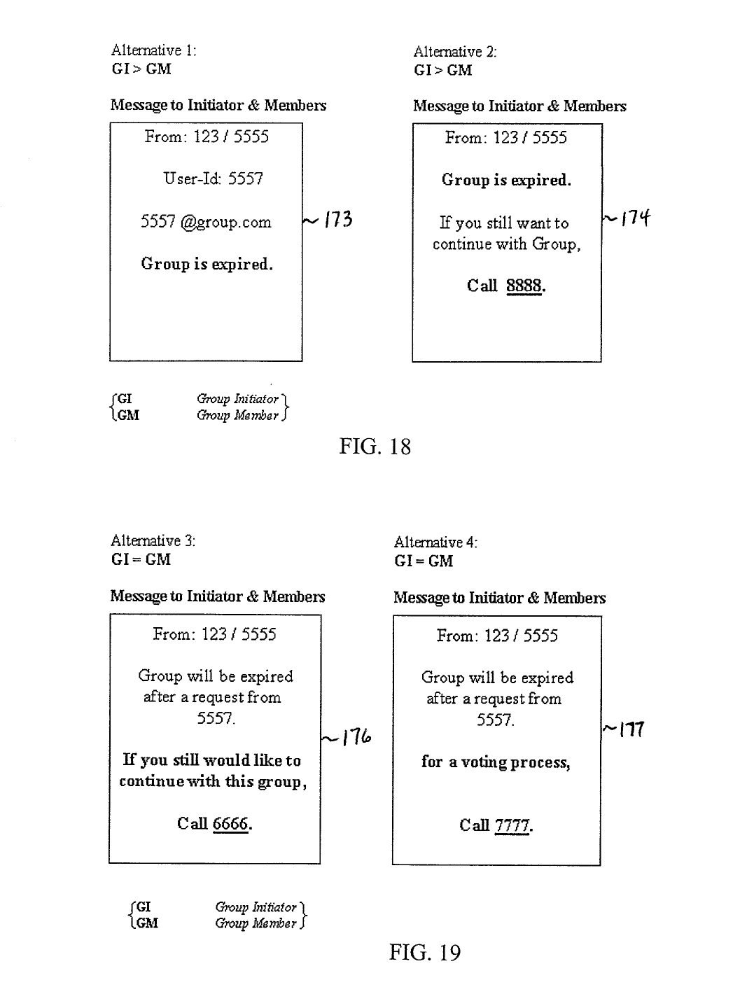

FIG. 19 illustrates two alternative exemplary notices that may be sent by the GES 10 to group members when the deletion of the group has been requested by a group member, and the GI and group members have equal power (i.e., GI=GM). In alternative-3 176, the group members are notified that member 5557 has requested the deletion of the group. The GES gives all the members another chance to continue with the group (or to establish a new group with the same properties) by calling a new number (e.g., 6666). In alternative-4 177, the group members are notified that member 5557 has requested the deletion of the group, and a number (e.g., 7777) is provided for the group members to call and vote whether to delete the group. The GES tallies the votes and continues the group if the voting supports it. If the voting does not support the continuation of the group, the group is deleted, and members voting to continue the group may be offered another number to call to establish a new group with the same properties.

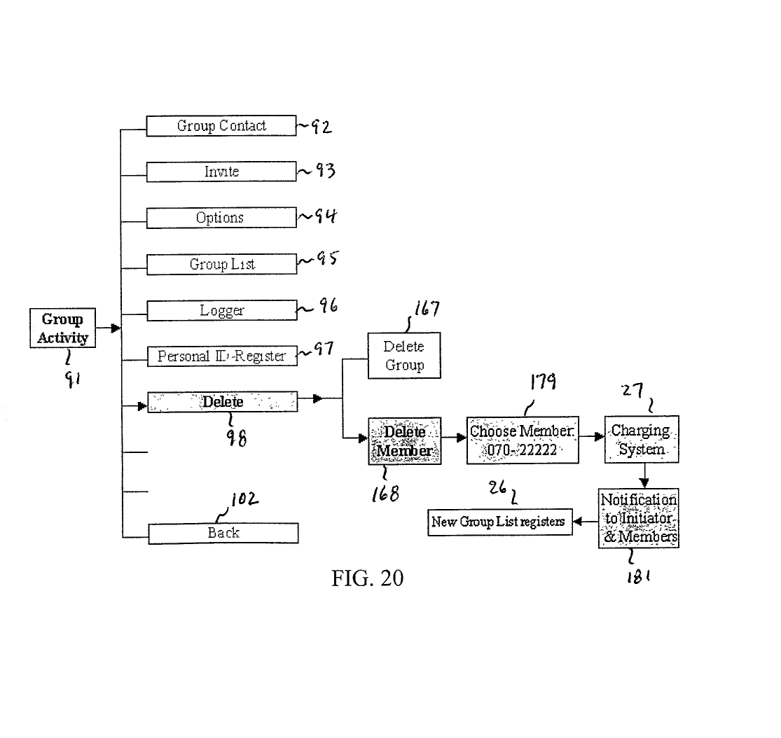

FIG. 20 is a functional block diagram of the “Delete Member” sub-feature 168 of the GES 10. This sub-feature makes it possible for the group members to unsubscribe themselves, or to delete another member from the group. For example, member 070-22222 may be chosen for deletion at step 179. The Charging System 27 determines any final charges relating to the deleted member, and notifications are sent to the GI and members at step 181. There are two different scenarios depending on whether GI>GM or GI=GM, and different notifications are sent for each scenario.

FIG. 21 illustrates two exemplary notices that may be sent by the GES 10 following the deletion of a member when GI>GM. In this case, the GI, and only the GI, has the power to delete group members. Of course, group members can unsubscribe themselves at any time, even when GI=GM. In alternative-1, a notification 183 is sent to the remaining group members, and informs them of the identity of the deleted member. In alternative-2, a notification 184 is sent from the GES to the deleted group member or to a member who has unsubscribed. If the group member was deleted by the GI, the member may be offered the chance to join another group in the GES. If the group member unsubscribed, the member may be offered the chance to rejoin the group.

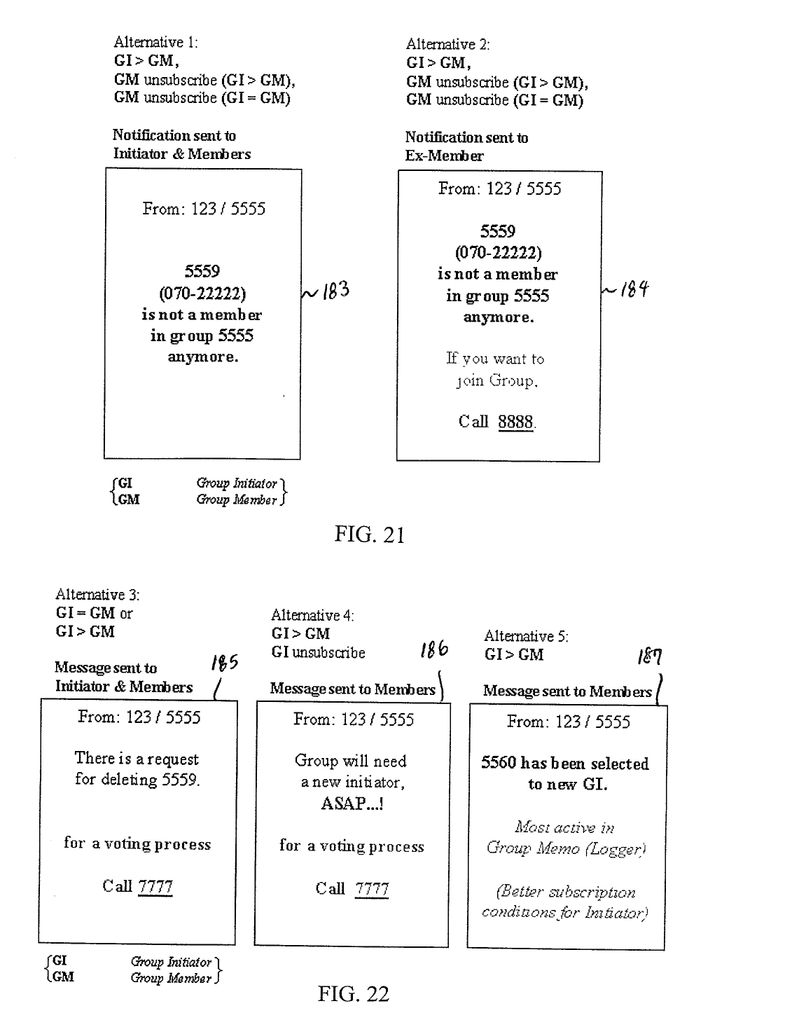

FIG. 22 illustrates three exemplary notices that may be sent by the GES 10 when the deletion of a member has been requested, and either GI>GM or GI=GM. In alternative-3, the GES sends a notification 185 to all group members when there is a request to delete a member. This case can exist, when either GI>GM or GI=GM. The GES asks everyone in the group to join a voting system, and the member is either voted out or retained. In alternative-4, the GI has requested to unsubscribe, but has indicated that the group can continue. In this case, the notification 186 asks all group members to vote for another GI. In a variation on this alternative, the GI may unsubscribe and designate a new GI to the GES. In alternative-S, the GI has unsubscribed, and the notification 187 indicates that the GES has chosen a new GI. The GES may use a variety of criteria for choosing the new GI such as choosing the most active member by looking at the member's activity in Logger 96. This could provide an incentive for members to be more active in the group, especially if there is a charging system in the group, and the GI is offered a lower subscription rate. The GES may also designate a new GI every month depending on who has been most active in the group during the month.

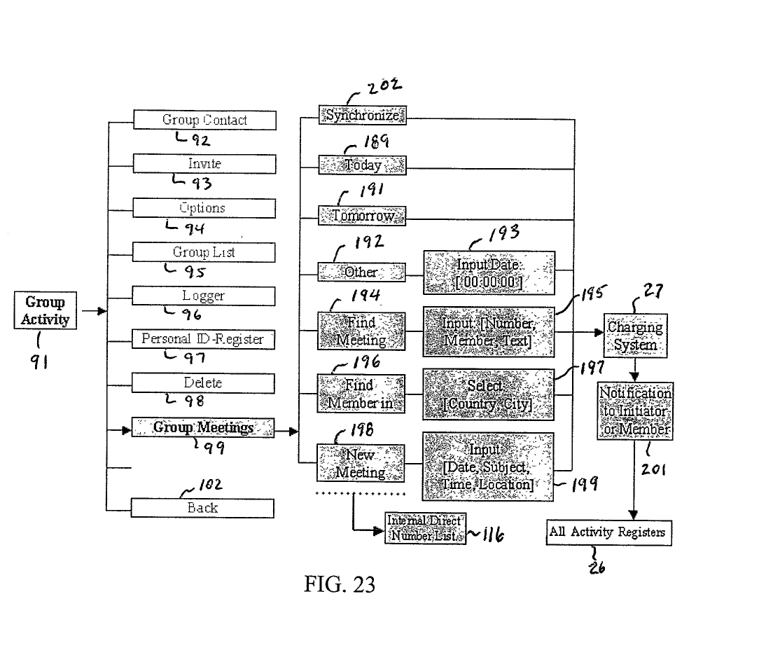

FIG. 23 is a functional block diagram of the Group Meetings feature 99 of the GES 10. Group meetings can be a great asset if they are planned properly and administered effectively. With this feature, all group members are able to check or book GES internal group appointments. As shown, the members can check Today's meetings 189, Tomorrow's meetings 191, or check for meetings on Other dates 192 by inputting the requested date at 193. Members can also use the “Find Meeting” sub-feature 194 to look for records of an old meeting using a GES internal search engine. Search criteria regarding the old meeting are input at 195. A group member can use the “Find Member In” sub-feature 196 to check the location of other group members before he books a meeting. The requested location is input at 197. For example, the member can ask the GES, “Who is in Stockholm now?”, and receive a list of members currently located in Stockholm. The “New Meeting” sub-feature 198 may then be used to set up the meeting. Data regarding the date, subject, time, and location of the meeting are input at 199. After the Charging System 27 determines whether there are any charges involved, notifications are sent to the GI or invited members at 201, and the transaction is registered in the GES database 26. The “Synchronize” sub-feature 202 is a software program that may be down-loaded from the Internet for synchronization between GES and, for example MS-Outlook to better control the notifications.

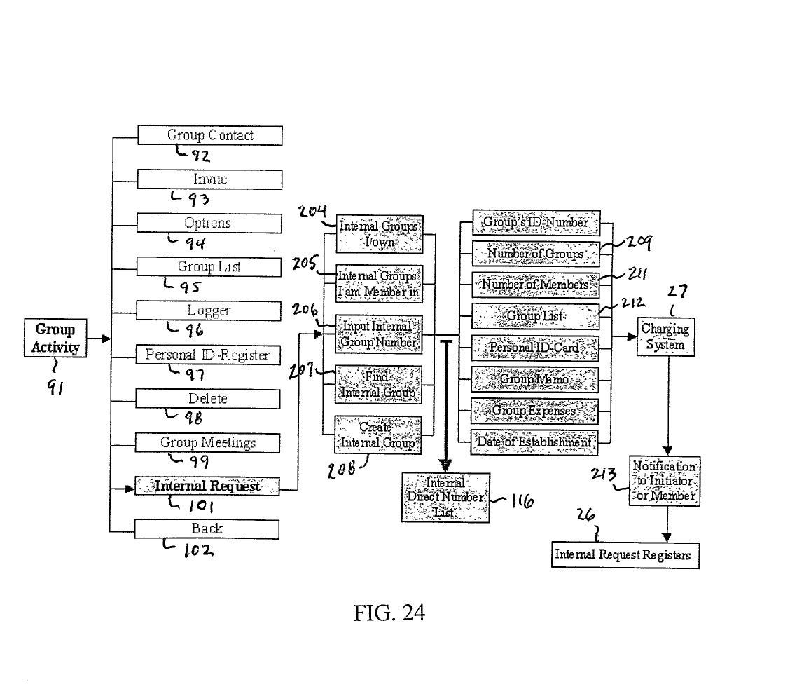

FIG. 24 is a functional block diagram of the Internal Request feature 101 of the GES 10. This feature provides group members with the ability to establish and organize new groups through the GES when they are already in an existing GES group. At 204, all group members can check the groups they own (i.e., for which they are the GI). At 205, group members can check the groups in which they are only members. At 206, they can request information about particular groups. At 207, they can look for specific internal groups utilizing the GES internal search engine. At 208, they can create new internal groups. For every Internal Request, group members can have different sub-requests such as “Number of Groups” 209, “Number of Members” 211, “Group List” 212, and the like. After the Charging System 27 determines whether there are any charges involved, notifications are sent to the GI or members at 213, and the transaction is registered in the GES database 26.

Database Registration

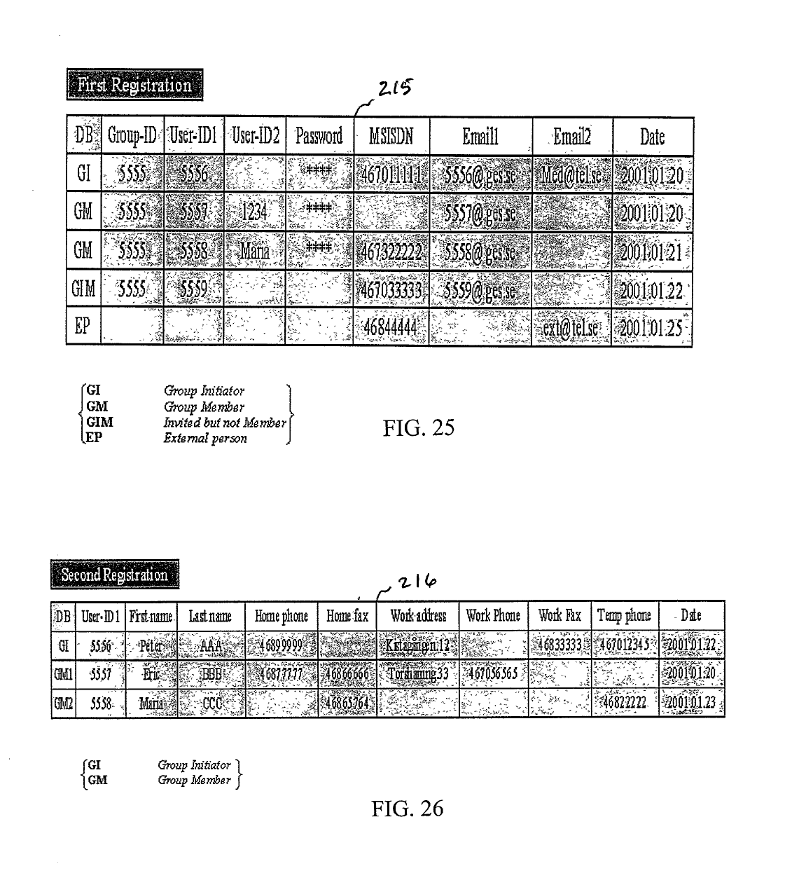

FIG. 25 is a database table 215 illustrating the first registration in the GES database 26 when a group is first established, and the GI, members, invitees, and external persons have their first contact with the GES 10. Personal user-IDs and e-mail addresses are registered by date for all members and invitees. Thereafter, all activities and all events in the group from the date of establishment to the date of group deletion are registered in the GES database.

FIG. 26 is a database table 216 illustrating a subsequent registration in the GES database 26 wherein group members enter data for their Personal ID-Cards.

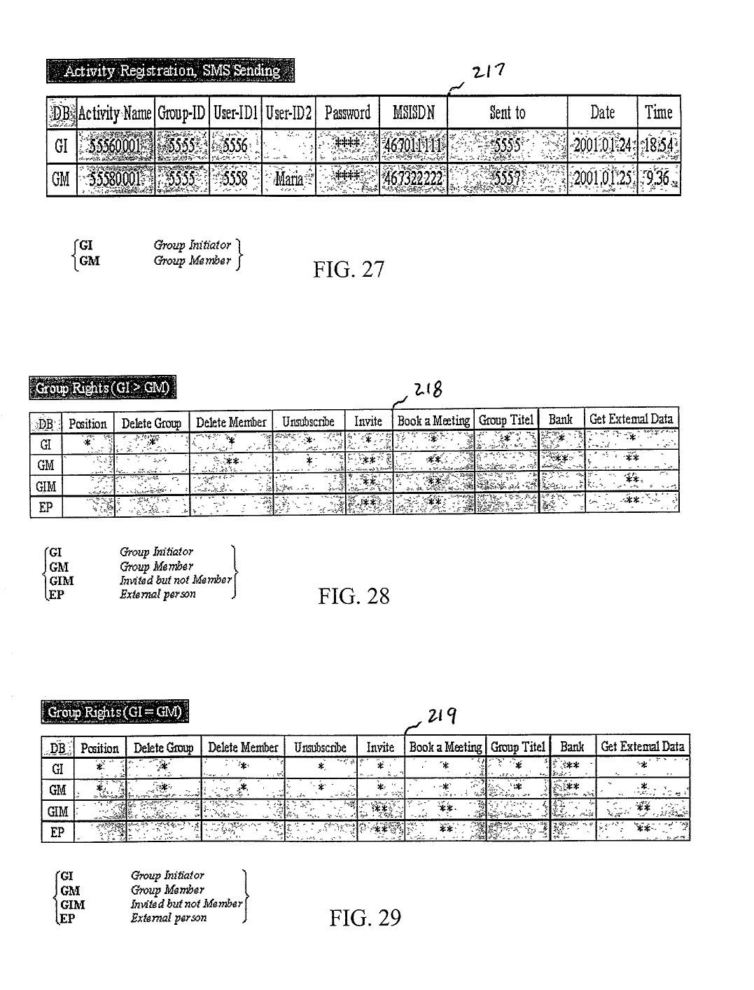

FIG. 27 is a database table 217 illustrating the registration of an activity in the GES database 26. All activities and events are registered in the GES database with special names and numbers. In the case shown, the activity is the sending of SMS messages by the GI and another member.

FIG. 28 is a database table 218 illustrating the rights which the GI and others hold, and the priority of those rights when GI>GM. Primary rights are shown with a single asterisk, and secondary rights are shown with two asterisks. Thus, the GI has the primary right to all activities in the group. Group members, on the other hand, have secondary rights in some of the activities.

FIG. 29 is a database table 219 illustrating the rights which the GI and others hold, and the priority of those rights when GI=GM. Once again, primary rights are shown with a single asterisk, and secondary rights are shown with two asterisks. Thus, all group members have the same group rights in all group activities. Invitees and external persons have only secondary rights.

External Persons

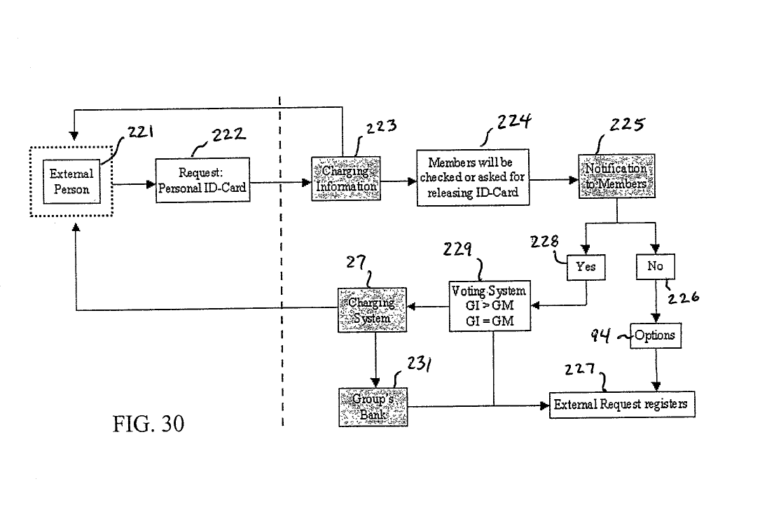

FIG. 30 is a flow chart of a process by which the GES 10 deals with external persons who are not group members. In one scenario, an external person has heard about the group, the group ID-number, or the group members, and the external person contacts the group using the group number. The group, however, is already closed, and no one else can join the group. The external person, however, is interested in a particular activity, event, or information in the group, and the group members have decided to sell information about group meetings, group events, and member information to external persons.

By contacting the group, the external person may be provided with several options, and the cost associated with each option. In the example shown, the external person 221 requests information from the members' Personal ID-Cards at step 222. At step 223, charging information is sent to the external person. As noted above, every group member has the right to determine whether they want to release/sell any of their personal information at all, so at step 224, the GES checks each group member's register to determine who has already indicated in Options 94 that they do not want to release their Personal ID-Cards. Those members so indicating are not asked to release any information, and none is released. For all other group members, a notification is sent at step 225 asking them if they will release their Personal ID-Card information or their activities to the external person. If a member says No at step 226, the decision is registered in Options 94, and then the external request is registered at step 227. If a member says Yes at step 228, their Personal ID-Card information is provided to the external person.

If the external person is also interested in obtaining information about the group's activities, the whole group is given the opportunity to vote whether to provide the information at step 229. If the members vote to provide the activities information, this fact is reported to the Charging System 27. The Charging System reports the total charge to the external person and to the Group Bank System 231 for the group. All incoming money is saved in the group's bank. If the group has expenses, the money in the bank is taken out to cover them.

Benefits

It can thus be seen from the above description that the GES of the present invention offers numerous benefits both to end users and to operators. Users of wireless devices such as GSM phones, WAP phones through the GSM network, and even Internet users are given the ability to establish a group and maintain contact with other members of the group through the contact lists of their friends and colleagues. By entering a feature, a member can make a request from the group list. The list can also be sent to the member's mobile phone or PC at any time. Anyone can be a user, including people who merely want to stay in contact with their friends, and business people who want to organize their work and establish better contact with their colleagues. The GES is easy to use, secure, and is device-, network-, and location-independent.

The GES also provides operators with a comprehensive environment in which to deploy additional value-added services to their users and to charge for their use. The GES also provides operators with an integrated platform between wireless, wireline and IP-networks, thus providing a way to link their installed base of services to IP networks.

It is thus believed that the operation and construction of the present invention will be apparent from the foregoing description. While the system and method shown and described has been characterized as being preferred, it will be readily apparent that various changes and modifications could be made therein without departing from the scope of the invention as defined in the following claims.

What is claimed is:

1. A method of establishing a group of communicating individuals utilizing a Group Establishment System (GES), said method comprising the steps of:
setting up a group number by the GES in response to a call from a Group Initiator (GI);
receiving a call to the group number in the GES from at least one potential group member who has been provided with the group number by the GI;
adding as a member in the group, each potential group member from whom a call to the group number is received in the GES; and
continuing the group in the GES after the GI and group members have terminated their calls to the GES.

2. The method of establishing a group of communicating individuals of claim 1 wherein the GES includes a plurality of different types of communication interfaces, and the step of receiving a call in the GES from at least one potential group member includes receiving a call from any one of a plurality of different types of client communication devices.

3. The method of establishing a group of communicating individuals of claim 2 wherein the step of receiving a call from any one of a plurality of different types of client communication devices includes receiving a call from a fixed telephone through a wireline GES interface with a Public Switched Telephone Network (PSTN).

4. The method of establishing a group of communicating individuals of claim 2 wherein the step of receiving a call from any one of a plurality of different types of client communication devices includes receiving a call from a computing device through a modem and the wireline GES interface with the PSTN.

5. The method of establishing a group of communicating individuals of claim 2 wherein the step of receiving a call from any one of a plurality of different types of client communication devices includes receiving a call from a mobile telephone through a wireless GES interface with a Public Land Mobile Network (PLMN).

6. The method of establishing a group of communicating individuals of claim 5 wherein the step of receiving a call from a mobile telephone includes receiving a voice call from the mobile telephone through the wireless GES interface with the PLMN.

7. The method of establishing a group of communicating individuals of claim 5 wherein the step of receiving a call from a mobile telephone includes receiving a Short Message Service (SMS) message from the mobile telephone through the wireless GES interface with the PLMN.

8. The method of establishing a group of communicating individuals of claim 2 wherein the step of receiving a call from any one of a plurality of different types of client communication devices includes receiving a message from a Wireless Application Protocol (WAP) mobile telephone through the Internet and a WAP GES interface with the Internet.

9. The method of establishing a group of communicating individuals of claim 2 wherein the step of receiving a call from any one of a plurality of different types of client communication devices includes receiving a message from a computing device through the Internet and a Web GES interface with the Internet.

10. A method of establishing and managing a group of communicating individuals utilizing a Group Establishment System (GES), said method comprising the steps of:
establishing as a group, a Group Initiator (GI) and a plurality of group members from whom a call to a group number is received in the GES;
continuing the group in the GES after the GI and group members have terminated their calls to the GES; and
utilizing a plurality of different types of communication interfaces in the GES to communicate information to and from the GI and the group members.

11. The method of establishing and managing a group of communicating individuals of claim 10 wherein the plurality of different types of communication interfaces include a wireline GES interface with a Public Switched Telephone Network (PSTN), a wireless GES interface with a Public Land Mobile Network (PLMN), a Wireless Application Protocol (WAP) GES interface with the Internet, and a Web GES interface with the Internet.

12. The method of establishing and managing a group of communicating individuals of claim 10 further comprising enabling each group member to customize his membership in the group by adding and subtracting group features.

13. The method of establishing and managing a group of communicating individuals of claim 10 further comprising the steps of:
establishing within the GES, a set of activities for the group members; and
providing access for each of the group members to the set of activities through any one of a plurality of different types of communication devices.

14. The method of establishing and managing a group of communicating individuals of claim 13 further comprising the steps of:
enabling a group member accessing an activity to designate other group members to participate in the activity; and
sending notices from the GES to the designated group members informing them of the activity.

15. The method of establishing and managing a group of communicating individuals of claim 14 wherein the GES includes a charging system, and the method further comprises the steps of:
determining in the GES whether a charge is associated with a particular activity; and
calculating a charge for each member who participates in the particular activity.

16. The method of establishing and managing a group of communicating individuals of claim 15 further comprising the step of sending a notification from the GES to each designated group member informing each designated group member of the charge for the activity.

17. The method of establishing and managing a group of communicating individuals of claim 13 further comprising the step of logging each activity performed by each group member in a GES database.

18. The method of establishing and managing a group of communicating individuals of claim 10 further comprising the steps of:
registering for each group member, information about the member in a GES database; and
selectively offering access to each member's information to other members of the group.

19. The method of establishing and managing a group of communicating individuals of claim 18 further comprising the step of selectively offering access to each member's information to persons outside the group.

20. The method of establishing and managing a group of communicating individuals of claim 10 further comprising the steps of:
receiving in the GES, a request from the GI to delete the group;
determining by the GES whether the GI is authorized to delete the group without approval from the group members; and
deleting the group by the GES upon determining that the GI is authorized to delete the group without approval from the group members.

21. The method of establishing and managing a group of communicating individuals of claim 20 further comprising, upon deleting the group, the step of sending a notification of group deletion from the GES to the GI and the group members.

22. The method of establishing and managing a group of communicating individuals of claim 21 wherein the step of sending a notification of group deletion includes sending, from the GES to the group members, a second group number and an indication that interested group members can continue the group by calling the second group number.

23. The method of establishing and managing a group of communicating individuals of claim 20 further comprising, upon determining by the GES that the GI is not authorized to delete the group without approval from the group members, the steps of:
obtaining a vote from the group members regarding whether the group is to be deleted; and
deleting the group upon determining that the group members have voted to delete the group.

24. A Group Establishment System (GES) for establishing a group of communicating group members, said GES comprising:
a main program that includes:
a group number generator that assigns a group number to the group in response to receiving a call from a Group Initiator (GI); and
a new member generator that adds as a new member in the group, each individual from whom a call to the group number is received in the GES;
a plurality of communication interfaces in communication with the main program, each of said communication interfaces enabling a group member utilizing a different type of client communication device to communicate with the main program; and
a GES database that stores member information and continues the group in the GES after the GI and group members have terminated their calls to the GES.

25. A Group Establishment System (GES) for managing a group of communicating group members, said GES comprising:
a main program that sets up meetings and provides activities for the group members; and
a plurality of communication interfaces in communication with the main program, each of said communication interfaces enabling a group member utilizing a different type of client communication device to communicate with the main program.

26. The GES of claim 25 further comprising a GES database in communication with the main program that stores member information for each of the group members, and that logs activities performed by each group member.

27. The GES of claim 26 further comprising a charging system that determines charges associated with the activities performed by each group member.

28. The GES of claim 27 wherein the main program includes a communication function that generates a notification to group members who incur a charge by participating in an activity that has a charge associated therewith.

29. The GES of claim 26 wherein the main program includes a deletion function that deletes the group upon receiving a request to delete the group from a Group Initiator (GI), and upon determining that the GI is authorized to delete the group.

30. The GES of claim 29 wherein the main program includes a communication function that generates notifications to group members, and the deletion function also deletes the group upon receiving a request to delete the group from a group member after the communication function sends a notification of group deletion to the group members, and after the main program provides the group members with a second group number and an indication that interested group members can continue the group by calling the second group number.
